(19) United States
(12) Patent Application Publication
(10) Pub. No.: US 2026/0184204 A1
(43) Pub. Date: Jul. 2, 2026

(54) WORK MACHINE BATTERY SYSTEM WITH INTEGRATED MULTI-SOURCE CHARGING CAPABILITY

(71) Applicant: Caterpillar Inc., Peoria, IL (US)

(72) Inventor: Eric M. Andris, Dunlap, IL (US)

(21) Appl. No.: 19/003,873

(22) Filed: Dec. 27, 2024

(51) Int. Cl. B60L 53/24; B60L 1/02; B60L 50/60; B60L 58/12; B60L 58/22

(52) U.S. Cl. CPC B60L 53/24; B60L 1/02; B60L 50/66; B60L 58/12; B60L 58/22; B60L 2200/40; B60L 2210/30; B60L 2210/42

(57) ABSTRACT

The present disclosure is directed to systems and methods for charging a battery array in a work machine. A system includes a battery array, a first power interface for receiving electrical energy at a first supply voltage, and a second power interface for receiving electrical energy at a second, lower supply voltage. An accessory power converter of the system selectively converts power from the battery array to an accessory or converts the lower voltage energy to charge the battery array. A controller assembly of the system detects power interface connections and controls battery charging through the detected connection, enabling flexible charging options for work machines.

### TECHNICAL FIELD

The present disclosure relates to technology configured to improve battery system of a work machine. More specifically, the present disclosure relates to work machine battery systems with integrated multi-source charging capability.

### BACKGROUND

Work machines, such as mining trucks, loaders, dozers, compaction machines, or other construction or mining equipment, have been traditionally powered by internal combustion engines. These engines have generally provided power to propulsion system components configured to move the work machine along a travel path, and typically also provide power to an electrical system associated with the work machine. However, the source of power of work machines as well as the use of the electrical systems have evolved. Whereas in the past, combustion engines have been the primary source of motive and electrical power, work machines are increasingly using battery systems which may include multiple battery modules as the primary source of energy, either augmenting an internal combustion system in the case of a hybrid work machine, or supplanting the internal combustion system altogether in the case of an electric, non-hybrid (EV) work machine.

Such battery systems discharge during use and can be charged, or recharged, between or during uses. WO2022006706A1 describes an integrated control device for new energy vehicles that combines multiple control functions. The device integrates control circuits for an on-board charger, DC/DC converter, and electric heater into a single integrated control circuit. The technology aims to reduce component count, optimize spatial layout, and lower manufacturing costs through this integration approach.

WO2019053369A1 discloses a vehicle battery charger with an integrated DC/DC converter functionality. The technology combines what were previously separate charging and DC/DC conversion functions into a single unit, sharing cooling and control circuits to reduce overall size and production costs.

### SUMMARY

In one aspect of the present disclosure, a system includes a battery array configured to supply power to a work machine, a first power interface configured to receive electrical energy at a first supply voltage from a first external power source for charging the battery array, and a second power interface configured to receive electrical energy at a second supply voltage from a second external power source, where the second supply voltage is lower than the first supply voltage. The system also includes an accessory power converter configured to selectively convert power from the battery array to power an accessory during a discharge mode, or convert electrical energy supplied at the second supply voltage to charge the battery array during a charge mode. A controller assembly is configured to detect a connection of one of the first power interface or the second power interface with an external power source and control charging of the battery array through the detected connection.

In another aspect of the present disclosure, a work machine includes an electric motor and a battery system powering the electric motor, as described herein.

In a further aspect of the present disclosure, a method includes providing a battery array configured to supply power to a work machine, providing first and second power interfaces configured to receive electrical energy at different supply voltages from external power sources for charging the battery array, and providing an accessory power converter with selective power conversion capabilities. The method further includes detecting a connection of one of the power interfaces with an external power source and charging the battery array through the detected connection.

In a still further aspect of the present disclosure, a system includes a battery array comprising multiple battery cells, first and second power interfaces for receiving electrical energy at different supply voltages, and at least one machine load power converter. The machine load power converter is configured to selectively convert power from at least one battery cell to power a machine load during a drive mode, or convert electrical energy supplied at the second supply voltage to charge the battery cell during a charging mode. A controller assembly is configured to detect power interface connections and control battery array charging through the detected connection.

### BRIEF DESCRIPTION OF DRAWINGS

FIG. 1 is a schematic illustration of an example work machine that travels over a surface, in accordance with embodiments of the present disclosure.

FIG. 2 is a schematic illustration of a battery system of a work machine.

FIG. 3 is a schematic illustration of a battery system of a work machine, in accordance with embodiments of the present disclosure.

FIG. 4 is a schematic illustration of a battery system of a work machine, in accordance with embodiments of the present disclosure.

FIG. 5 is a schematic illustration of a battery system of a work machine, in accordance with embodiments of the present disclosure.

FIG. 6 is a schematic illustration of a controller assembly of a battery system in accordance with embodiments of the present disclosure.

FIG. 7 is a schematic diagram illustrating components in a computing device in accordance with embodiments of the present disclosure.

FIG. 8 is a flowchart illustrating a process of charging a battery system, in accordance with embodiments of the present disclosure.

### DETAILED DESCRIPTION

Systems and technologies described below are directed to XXX. Wherever possible, the same reference numbers will be used throughout the drawings to refer to the same or like parts.

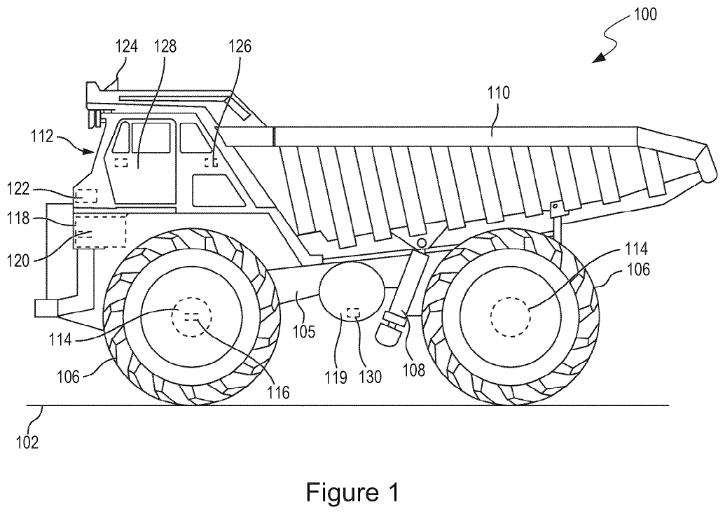

FIG. 1 is a schematic illustration of an example work machine 100 that travels over a surface 102, in accordance with examples of the disclosure. The work machine 100, although depicted as a mining truck type of machine, may be any suitable machine, such as any type of loader, dozer, dump truck, skid loader, excavator, compaction machine, backhoe, combine, crane, drilling equipment, tank, trencher, tractor, any suitable stationary machine, any variety of generator, locomotive, marine engines, combinations thereof, or the like. In some examples, the work machine can be a hybrid system, an electric vehicle (no internal combustion engine), or use internal combustion as the primary source of energy. The presently disclosed subject matter is not limited to any particular platform of use and may be implemented across various types of vehicles, installations (e.g., non-vehicle uses), and the like. The work machine 100 of FIG. 1 is merely for purposes of illustration.

As shown in FIG. 1, the work machine 100 includes a frame 105 and wheels 106. The wheels 106 are mechanically coupled to a drive train (not shown) to propel the work machine 100. When the wheels 106 of the work machine 100 are caused to rotate, the work machine 100 traverses the surface 102. Although illustrated in FIG. 1 as having a hub with a rubber tire, in other examples, the wheels 106 may instead be in the form of drums, chain drives, combinations thereof, or the like. The frame 105 of the work machine 100 is constructed from any suitable materials, such as iron, steel, aluminum, other metals, ceramics, plastics, the combination thereof, or the like. The frame 105 is of a unibody construction in some cases, and in other cases, is constructed by joining two or more separate body pieces. Parts of the frame 105 are joined by any suitable variety of mechanisms, including, for example, welding, bolts, screws, other fasteners, epoxy, combinations thereof, or the like.

The work machine 100 may include a hydraulic system 108 that moves a dump box 110 or other moveable elements configured to move, lift, carry, and/or dump materials. The dump box 110 is used, for example, to pick up and carry dirt or mined ore from one location on the surface 102 to another location of the surface 102. The dump box 110 is actuated by the hydraulic system 108, or any other suitable mechanical system. In some cases, the hydraulic system 108 is powered by an electric motor (not shown), such as by powering hydraulic pump(s) (not shown) of the hydraulic system 108. It should be noted that in other types of machines (e.g., machines other than a mining truck) the hydraulic system 108 may be in a different configuration than the one shown herein, may be used to operate elements other than a dump box 110, and/or may be omitted.

With continued reference to FIG. 1, the work machine 100 also includes an operator station 112. The operator station 112 is configured to seat an operator (not shown) therein. The operator seated in the operator station 112 interacts with various control interfaces and/or actuators within the operator station 112 to control movement of various components of the work machine 100 and/or the overall movement of the work machine 100 itself. Thus, control interfaces and/or actuators within the operator station 112 allow the control of the propulsion of the work machine 100 by controlling operation of one or more motors 114 that are electric motors, the motors 114 being controlled by a motor controller 116 and powered by a battery system 118. The battery system 118 includes one or more battery modules, each module having one or more cells that, when electrically connected, provide a battery. The motor controller 116 may be controlled according to operator inputs received at the operator station 112. A battery system controller 120 monitors and controls various aspects of the battery system 118, such as monitoring a temperature or SOC of the battery system 118 or the battery modules, or management of the charge levels of the battery system 118 or the battery modules.

The motors 114 may be of any suitable type, such as induction motors, permanent magnet motors, switched reluctance (SR) motors, combinations thereof, or the like. The motors 114 are of any suitable voltage, current, and/or power rating. The motors 114 when operating together are configured to propel the work machine 100 as needed for tasks that are to be performed by the work machine 100. For example, the motors 114 may be rated for a range of about 500 volts to about 3000 volts. The motor controller 116 includes control electronics configured to control the operation of the motors 114. In some cases, each motor 114 may be controlled by its own motor controller 116. In other cases, all the motors of the work machine 100 may be controlled by a single motor controller 116. The motor controller 116 may further include one or more inverters or other circuitry to control the energizing of magnetic flux generating elements (e.g., coils) of the motors 114. The motors 114 are mechanically coupled to a variety of drive train components, such as a drive shaft and/or axles or directly to the wheels 106 to rotate the wheels 106 and propel the work machine 100.

The drivetrain includes any variety of other components including a differential, connector(s), constant velocity (CV) joints, etc. Although not shown here, there may be one or more motors 114 that are not used for propulsion of the work machine 100, but rather to operate pumps and/or other auxiliary components, such as to operate the hydraulic systems 108. According to examples of the disclosure, the power to energize the motors 114 is received from the battery system 118. It should be noted that, in some cases, the battery system 118 may provide power for operating the motors 114 and/or other power consuming components (e.g., controllers, cooling systems, displays, actuators, sensors, etc.) of the work machine 100. As noted above, the presently disclosed subject matter is not limited solely to the use of battery power, as other forms of energy may be used in conjunction with the power provided by the battery system 118, including internal combustion engines or fuel cells.

The battery system 118 may be of any suitable type and capacity. For example, the battery module can be a lithium ion battery, a lead-acid battery, an aluminum ion battery, a flow battery, a magnesium ion battery, a potassium ion battery, a sodium ion battery, a metal hydride battery, a nickel metal hydride battery, a cobalt metal hydride battery, a nickel cadmium battery, a wet cell of any type, a dry cell of any type, a gel battery, combinations thereof, or the like. The battery system 118 may be organized as a collection of electrochemical cells arranged to provide the voltage, current, and/or power requirements of the motors 114. In some cases, the energy capacity of the battery system 118 relative to the energy available from a full fuel tank 119 may be in the range of about 0.2 to about 1.5. In other cases, the energy capacity of the battery system 118 relative to the energy available from a full fuel tank 119 may be in the range of about 0.5 to about 1. In still other cases, the energy capacity of the battery system 118 relative to the energy available from a full fuel tank 119 may be in the range of about 0.7 to about 0.9. It should be understood that the aforementioned ratios are examples, and the disclosure contemplates the battery system 118 energy capacity to the fuel tank 119 energy capacity ratios in ranges outside of the aforementioned ranges.

The work machine 100 includes an electronic control module (ECM) 122 that controls various aspects of the work machine 100. The ECM 122 is configured to receive battery status (e.g., state-of-charge (SOC) or other charge related metrics) from the battery system controller 120, fuel level from the fuel tank controller 130, operator signal(s), such as an accelerator signal, based at least in part on the operator's interactions with one or more control interfaces and/or actuators of the work machine 100. In other cases, the ECM 122 may receive control signals from a remote-control system by wireless signals received via an antenna 124. The ECM 122 uses the operator signal(s), regardless of whether they are received from an operator in the operator station 112 or from a remote controller, to generate command signals to control various components of the work machine 100. For example, the ECM 122 may control the motors 114 via the motor controller 116, the hydraulic system 108, and/or steering of the work machine 100 via a steering controller 126. It should be understood that the ECM 122 may control any variety of other subsystems of the work machine 100 that are not explicitly discussed here to provide the work machine 100 with the operational capability discussed herein.

The ECM 122, according to examples of this disclosure, may be configured to provide an indication of remaining energy to operate the work machine 100 on an energy gauge 128. The energy gauge 128, according to examples of the disclosure, may be configured to display the amount of energy available to operate the work machine 100 based at least in part on the amount of charge remaining in the battery system 118. In some cases, the energy gauge 128 may provide an indication of an estimated amount of time the work machine 100 can be operated and/or an estimated amount of range the work machine 100 has remaining. These estimates may be generated based on the amount of charge remaining in the battery system 118, the recent usage of energy by the work machine 100, and/or an estimate of the energy expended per unit time (e.g., power requirement) of a task in which the work machine 100 is engaged. The energy gauge 128 may be configured to display, to an operator seated in the operator station 112, the amount of energy, time, and/or range remaining for operating the work machine 100. Additionally or alternatively, the energy gauge 128 and/or the ECM 122 may be configured to indicate, such as wirelessly via the antenna 124, the amount of energy, time, and/or range remaining for operating the work machine 100 to a remote operating system.

The ECM 122 includes single or multiple microprocessors, field programmable gate arrays (FPGAs), digital signal processors (DSPs), and/or other components configured to control the work machine 100. Numerous commercially available microprocessors can be configured to perform the functions of the ECM 122. Various known circuits are operably connected to and/or otherwise associated with the ECM 122 and/or the other circuitry of the work machine 100. Such circuits and/or circuit components include power supply circuitry, inverter circuitry, signal-conditioning circuitry, actuator driver circuitry, etc. The present disclosure, in any manner, is not restricted to the type of ECM 122 or the positioning depicted of the ECM 122 and/or the other components relative to the work machine 100. The ECM 122 is configured to control the use of energy from the battery system 118 in a manner that enhances the range of the work machine 100.

The work machine 100 further includes any number of other components within the operator station 112 and/or at one or more other locations on the frame 105. These components include, for example, one or more of a location sensor (e.g., global positioning system (GPS)), an air conditioning system, a heating system, communications systems (e.g., radio, Wi-Fi connections), collision avoidance systems, sensors, cameras, etc. These systems are powered by any suitable mechanism, such as by using a direct current (DC) power supply powered by the battery system 118.

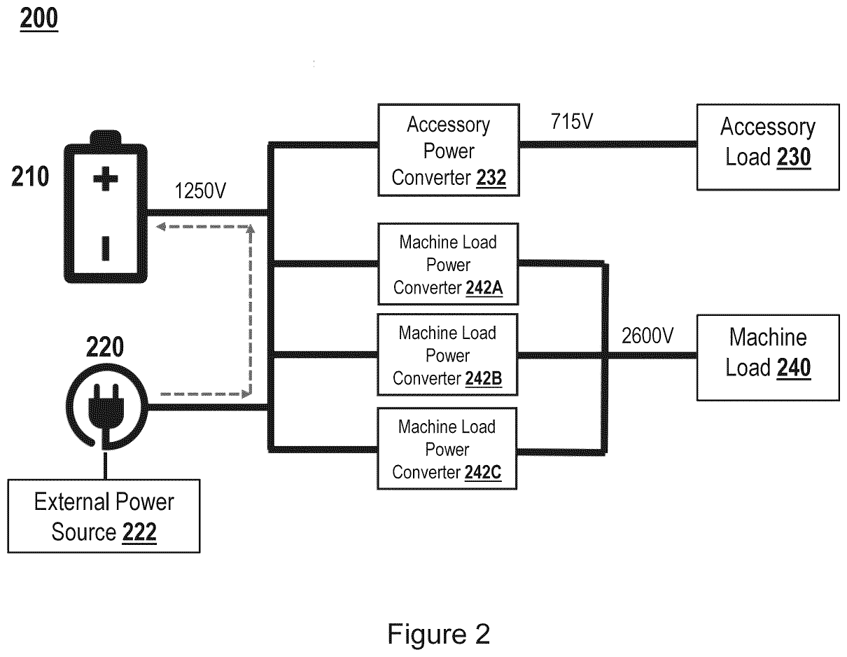

FIG. 2 illustrates a battery system for a work machine, in accordance with examples of the present disclosure. The battery system 200 (“system 200”) illustrates an exemplary implementation of the battery system 118 in FIG. 1.

The system 200 includes a battery array 210. The battery array 210 may be designed to operate within a normal voltage range of 1000V to 1500V, e.g., 1250V nominal. In some embodiments, the battery array 210 includes multiple battery modules electrically connected in series and/or parallel configurations to achieve the desired operating voltage. Each battery module may include multiple battery cells, with the cells within each module connected in series to increase voltage and/or in parallel to provide a desired current capacity.

The system 200 as illustrated employs a consolidated battery bus architecture. This consolidated bus architecture provides a centralized power distribution approach, where all power conversion and charging connections share a common high-voltage bus connected to the battery array. In alternative embodiments, the system 200 may implement a segmented architecture where the battery array includes multiple independently controllable battery segments (e.g., battery modules, battery cells), each with dedicated power conversion and/or charging interfaces. This segmented approach can provide enhanced flexibility in power distribution and charging operations, allowing different segments to be charged or discharged independently based on operational needs.

The system 200 includes a power interface 220 configured to receive electrical energy from an external power source 222. As illustrated, the external power source 222 connects directly to the consolidated battery bus, supplying electrical energy at the supply voltage of (approximately) 1500V. The charging current path is indicated by a dashed line from the power interface 220 to the battery array 210 in FIG. 2.

The system 200 may include power conversion components to facilitate operations within different voltage ranges. The system 200 includes an accessory power converter 232 that is configured to convert power from the battery array 210 (e.g., stepping down from 1500V from the battery array 210 to 715V) for powering an accessory load 230. Exemplary accessory loads include systems such as hydraulics, lighting, and climate control, which operate at lower power levels than the main drive system.

For high-power applications, the system 200 employs one or more machine load power converters 242 (individually identified as a first machine load power converter 242A, a second machine load power converter 242B, and a third machine load power converter 242C) connected in parallel. For illustration, these converters 242 collectively convert the 1500V from the battery array 210 to 2600V to power a traction load 240, such as electric drive motors. This parallel converter arrangement enables power delivery for high-demand applications.

While not shown in the figure, the system 200 includes a controller assembly. The controller assembly monitors and controls various aspects of the battery array, including voltage, current, temperature, and state of charge during both charging and discharging operations.

Due to high voltage needs of large battery electric machines, specialized charging solutions are needed. Such charging systems capable of delivering up to (approximately) 1500V are typically stationary installations that are expensive to deploy. This presents operational challenges when the machine is used in remote areas or at service facilities lacking high-voltage charging infrastructure.

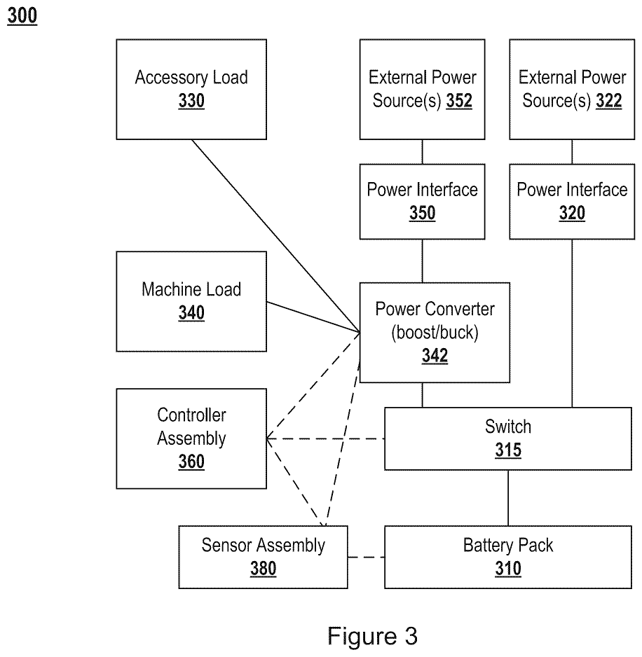

FIG. 3 is a schematic illustration of a battery system of a work machine, in accordance with examples of the present disclosure. Solid lines indicate power connections between system components; dashed lines indicate information communication paths. The battery system 300 (“system 300”) includes a battery array 310 that may include multiple battery cells or modules similar to the battery arrays described in FIGS. 2, 4, and 5.

The system 300 includes multiple power interface configurations for charging. A first power interface 320 connects to an external power source 322 that supplies electrical energy at approximately the nominal voltage of the battery pack 310. A second power interface 350 connects to an external power source 352 that supplies electrical energy at a voltage different from the battery pack's nominal voltage, requiring power conversion. In some embodiments, the second power interface is bidirectional and further configured to interface with a component (e.g., the accessory load 330) to output power from the battery array to the component.

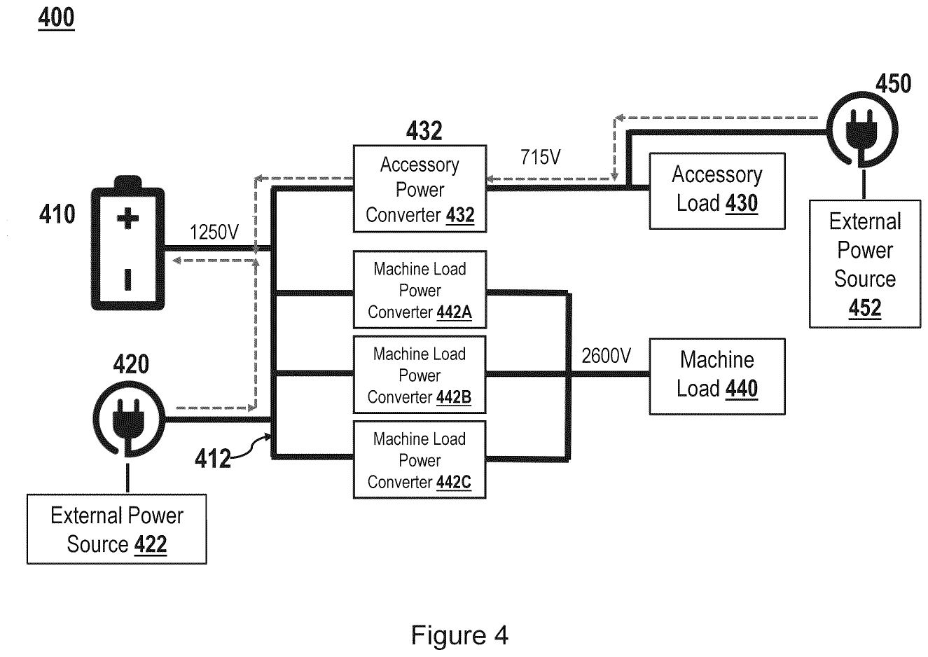

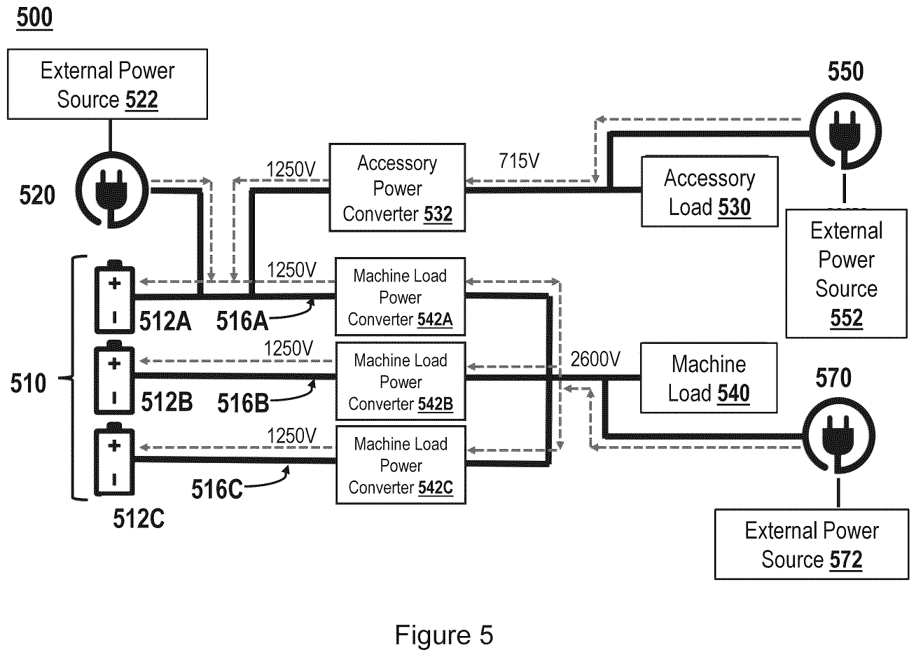

A power converter 342 may be bidirectional with boost and buck capabilities capable of managing voltage conversion for both charging and discharging operations. During charging, it can convert voltage from an external source to appropriate levels for the battery pack 310. During operation, it can convert battery power to supply a machine load 340 or an accessory load 330 at their required voltage levels. Although only one power converter 342 is illustrated in FIG. 3, the system 300 may include multiple power converters. See, e.g., power converters 432 and 442 in FIGS. 4 and 532 and 542 in FIG. 5.

A switch 315 represents a power routing and isolation device configured to control electrical connections between system components. Exemplary implementations include contactors for high-voltage DC switching, semiconductor switches for fast switching operations, circuit breakers for overcurrent protection, and disconnect switches for maintenance isolation. While FIG. 3 shows a single switch 315 for simplicity, the system 300 may include multiple switches strategically placed to manage different power paths. These switches isolate battery sections (e.g., isolating individual battery cells or battery modules of the battery array 310 among themselves, and/or isolating the battery array 310 from other system components), control charging paths, enable or disable power converter connections, provide emergency disconnection capability, and protect individual circuits. The placement and type of switches depend on system voltage levels, current requirements, and safety needs.

A sensor assembly 380 includes various types of sensors or sensing circuits (referred to as “sensors” for brevity) for monitoring system conditions. Temperature sensors monitor thermal conditions of both the battery pack 310 and power converter 342 components to prevent overheating. Voltage sensors measure individual cell and overall battery pack voltage levels, while current sensors monitor charging and discharging current flows through both the battery pack 310 and power converter 342. The state of charge (SOC) of the battery pack 310 may be calculated by the controller assembly 360 based on these measured voltage and current values.

For the power converter 342, additional sensors monitor converter operating conditions including input and output voltages, current flow through different conversion stages, and component temperatures. The sensor assembly 380 may also include insulation monitoring devices to detect electrical faults and pressure sensors to monitor battery enclosure conditions.

The sensor data is transmitted to a controller assembly 360 through communication interfaces such as CAN (Controller Area Network) buses, analog-to-digital converters, or other industrial communication protocols as indicated by the dashed lines. These physical communication components enable real-time data transmission, allowing the controller assembly 360 to monitor system conditions and adjust operations accordingly.

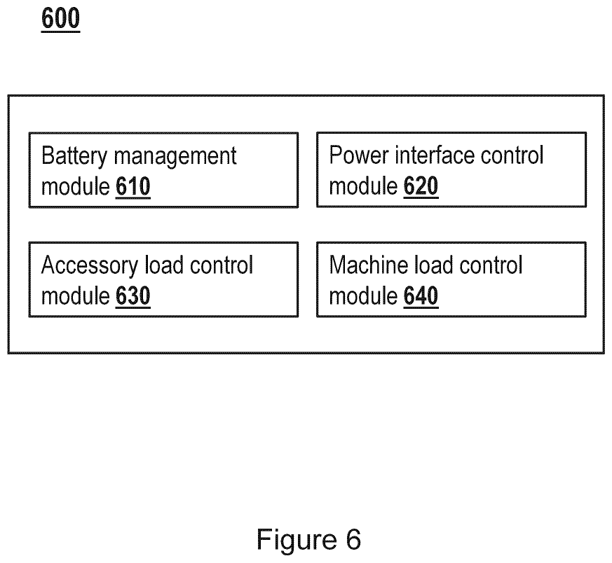

The controller assembly 360 provides comprehensive monitoring and control of system operations. Through connections indicated by dashed lines, it monitors and controls the power converter operation, manages the switch 315 for power routing, and receives input from the sensor assembly 380 that monitor conditions of the system components including the battery pack 310 and the power converter 342. For example, the controller assembly 360 monitors switch 315's states and controls the operation to manage power flow during both charging and operational modes, implementing safety interlocks and coordinating power distribution based on system conditions. The controller can regulate power conversion parameters, manage charging operations, and control power distribution to various loads based on system requirements and battery conditions. Additional description of the controller assembly 360 may be found in FIG. 6 and the description thereof.

The controller assembly 360 can be implemented (functionally) in both distributed architecture as illustrated in FIG. 6 (not repeated here), and consolidated architecture. In a consolidated implementation, a single centralized controller unit houses all processing hardware, including microprocessors, memory, and communication interfaces. This centralized unit manages all control functions including battery monitoring, charging control, and power conversion management. All sensor inputs and control outputs are processed through this single unit, which executes all control algorithms and coordinates all system operations. The consolidated approach may offer simpler system architecture and reduced hardware complexity, while the distributed approach provides more flexibility for system scaling and potentially better fault isolation.

The hardware of the controller assembly 360 may be (physically) centrally located or distributed at various locations. In a physically centralized implementation, all control hardware components are housed in a single enclosure or cabinet, even if the functions are distributed among different processing units. This central unit contains all circuit boards, processors, communication interfaces, and connection points, though it may still use multiple internal processors for different control functions.

In a physically distributed implementation, the control hardware is located in multiple enclosures positioned near their respective controlled components. For example, battery management hardware may be mounted near the battery array, charging control hardware near power interfaces, and power conversion control hardware near the converters. Each location houses the processing and interface components needed for its specific control functions, with communication links connecting these distributed units.

Both functional and physical distribution can be mixed-for instance, functionally distributed control may be housed in a single physical enclosure, or functionally centralized control may be implemented across physically distributed hardware units. The choice may depend on factors like cable routing efficiency, environmental protection requirements, and maintenance accessibility.

This architecture shown in FIG. 3 provides the fundamental framework for the more detailed implementations shown in FIGS. 4 and 5, where the basic concepts are expanded into specific configurations. The system 300 enhances charging flexibility by utilizing existing power conversion components and existing charging infrastructure.

The advantage of this architecture includes its ability to expand charging capabilities without requiring additional dedicated charging components. The power converter 342, which normally manages power distribution for machine and/or accessory loads during operation, can also regulate charging power from external sources with different voltage levels. This dual-use of existing components enables charging flexibility while minimizing system complexity and cost.

The system 300 enables charging through various existing infrastructure. For high-voltage charging through the first power interface 320, specialized power sources 322 supply voltage (substantially) matching the battery array 310's normal voltage range (e.g., 1000V-1500V, with 1250V nominal). For charging through the second power interface 350, the system 300 can utilize standard electric vehicle DC fast charging stations that typically supply 400V to 900V, or AC charging stations providing 240V to 480V three-phase power.

The system 300 can also use power from industrial electric drive infrastructure, such as mining truck trolley lines, railway catenary systems, industrial DC bus systems, industrial distribution networks that typically supply higher voltages (e.g., above 1500V), etc., as external power sources. For example, the second external power source may supply electrical energy at a supply voltage in the range from 1500 V to 3000 V, or from 2000 V to 3000 V. This ability to use existing industrial power infrastructure expands charging options without requiring dedicated high-voltage charging stations.

By leveraging the bidirectional power converter 342 to manage voltage conversion, the system 300 can charge the battery pack 310 from these diverse power sources while minimizing additional components. This enables flexible charging options using established infrastructure, particularly beneficial in industrial or remote locations where installing specialized high-voltage charging stations may be impractical or cost-prohibitive.

FIG. 4 illustrates a battery system for a work machine, in accordance with examples of the present disclosure. The battery system 400 (“system 400”) illustrates an exemplary implementation of the battery system 118 in FIG. 1. The system 400 includes two distinct charging options to enhance charging flexibility. A first option maintains compatibility with high-voltage charging through a first power interface 420 receiving electrical energy, e.g., at the nominal voltage of the battery array 410, similar to the charging configuration described in reference to FIG. 2. A second option enables charging by receiving, through a second power interface 450, electrical energy at a lower voltage, with an accessory power converter 432 regulating the power flow to charge the battery array 410. This dual-charging capability addresses operational challenges in areas lacking high-voltage charging infrastructure.

The system 400 includes a battery array 410. The battery array 410 may be configured to operate within a normal voltage range, such as 1000V to 2000V, for example 1500V under normal conditions. In some embodiments, the battery array 410 may include multiple battery modules and/or multiple battery cells electrically connected in series and/or parallel configurations to achieve a desired operating need (e.g., desired voltage and/or current capacities). The battery array 410 may incorporate features of the battery array 210 described in reference to FIG. 2.

The system 400 employs a consolidated battery bus architecture where the battery array 410 interfaces with system components through a common high-voltage bus 412. This centralized approach connects the battery array 410 through a shared power distribution point to: (1) the first power interface 420 and second power interface 450 for charging, and (2) the power converters including accessory power converter 432 and machine load power converters 442 for power distribution.

The consolidated bus 412 is configured to receive high-voltage charging input (approximately 1500V) from the first power interface 420 and distribute power to the accessory power converter 432 and machine load power converters 442. The accessory power converter 432 may step down voltage from 1500V to 715V for the accessory load 430, while the machine load power converters 442 may boost the voltage of the battery array 410 to 2600V for the mechine load 440.

During charging through the second power interface 450, the accessory power converter 432 regulates power flow by converting the lower input voltage (e.g., 400V-1200V) from the second external power source 452 to the battery array 410's normal voltage range (e.g., 1000V-1500V, with 1250V nominal). This consolidated bus architecture routes all charging and power conversion operations through a single high-voltage connection point, enabling efficient centralized power distribution.

The system 400 includes the first power interface 420 configured to receive electrical energy from a first external power source 422 for charging the battery array 410. As illustrated, the first external power source 422 may connect to the battery array 410, supplying electrical energy at a first supply voltage (or referred to as input voltage), which may be approximately 1500V. The charging current path from the first power interface 420 may be indicated by the dashed line from the first power interface 420 to the battery array 410 in FIG. 4. The first power interface 420 may incorporate features of the power interface 220 described in reference to FIG. 2. The first external power source 422 may be the same as or similar to the external power source 222 described in reference to FIG. 2.

The system 400 includes the second power interface 450 configured to receive electrical energy from a second external power source 452 for charging the battery array 410. The second external power source 452 may supply electrical energy at a second supply voltage that is lower than the first supply voltage. For example, the second supply voltage may be in a range of 400V to 1200V, enabling charging from a wide range of existing charging infrastructure including, e.g., standard electric vehicle charging infrastructure. The second external power source 452 may be a standard mobile charger or charging system that complies with electrical specifications for electric vehicle charging defined in industry standards such as SAE J1772, IEC 61851, CHAdeMO, or CCS (Combined Charging System). The second power interface 450 may include standard charging connectors compatible with these charging systems, such as J1772 connectors for AC charging, CHAdeMO or CCS connectors for DC fast charging, and standard DC sockets. In some embodiments, the second power interface 450 is bidirectional and further configured to interface with a component (e.g., an accessory) to output power from the battery array to power the component (the accessory load 430).

The system 400 may include power conversion components to facilitate operations within different voltage ranges. The system 400 includes an accessory power converter 432. The accessory power converter 432 may be bidirectional, which can selectively operate in two modes. In a discharge mode, the accessory power converter 432 converts power from the battery array 410 to an accessory load 430 (e.g., stepping down from 1500V from the battery array 410 to 715V) for powering the accessory load 430. Exemplary accessory loads include systems such as hydraulics, lighting, and climate control, which operate at lower power levels than the main drive system. In a charge mode, it converts electrical energy received through the second power interface 450 to charge the battery array 410. This dual-mode capability, combined with compatibility with established charging standards, enables the work machine to utilize existing electric vehicle charging infrastructure when high-voltage charging stations are not available.

For high-power applications, the system 400 may employ one or more machine load power converters 442 (individually identified as a first machine load power converter 442A, a second machine load power converter 442B, and a third machine load power converter 442C) connected in parallel. These converters 442 may collectively convert power from the battery array 410 to power a machine load 440, such as electric drive motors. The machine load power converters 442 may incorporate features of the machine load power converters 242 described in reference to FIG. 2.

The system 400 includes a controller assembly (not shown), e.g., the controller assembly 360 as illustrated in FIG. 3 and the controller assembly 600 as illustrated in FIG. 6. The controller assembly may monitor various aspects of the battery array 410, including voltage, current, temperature, and state of charge during both charging and discharging operations. The controller assembly may be configured to detect the connection between a power interface (e.g., 420 or 450) and an external power source (e.g., 422 or 452), and control charging operations through the detected connection.

The controller assembly may distribute charging current based on state of charge levels of individual battery modules or cells within the battery array 410. When charging through the second power interface 450, the controller assembly may regulate power flow through the accessory power converter 432 at a reduced power level compared to charging through the first power interface 420. This power regulation helps ensure safe and efficient charging despite the lower supply voltage from the second external power source 452.

The controller assembly enables coordinated control of multiple system components. It may manage the bidirectional operation of the accessory power converter 432, switching between charge and discharge modes based on system needs. The controller assembly may also monitor and control the machine load power converters 442 during high-power operations, ensuring proper power delivery to traction loads 440.

The system 400 may include one or more inverters for converting DC power from the battery array to AC power for driving electric motors or other AC loads. A bidirectional inverter may be connected to the accessory power converter 432 to enable both AC power output to accessory loads and AC power input for battery charging through power interface 450. For example, the bidirectional inverter is connected between the accessory power converter 432 and the accessory load 430. The controller assembly coordinates operation of these inverters along with other power conversion components to manage both machine operation and charging functions.

In the consolidated bus architecture of FIG. 4, the controller assembly manages power flow through a centralized high-voltage connection point. During charging through the first power interface 420, it monitors direct high-voltage charging via the consolidated bus. When charging through the second power interface 450, it controls the accessory power converter 432 to regulate power flow through this shared connection point. The consolidated architecture enables the controller assembly to coordinate power conversion and distribution operations through a single monitored and controlled interface.

FIG. 5 illustrates an enhanced battery system for a work machine, in accordance with examples of the present disclosure. The system includes a segmented battery array 510 with multiple battery cells (510A, 510B, 510C) individually or collectively operating at a normal voltage range of 1000V to 1500V, e.g., 1250V nominal. Unlike the consolidated bus architecture in FIG. 4, the system 500 employs a segmented battery bus architecture where battery cells can be independently charged and controlled.

The system 500 employs three charging options for charging the battery array 510. A first option maintains compatibility with high-voltage charging through a first power interface 520 receiving electrical energy, e.g., at the nominal voltage of the battery array 510, similar to the charging configuration through the first power interface 420 described in reference to FIG. 4. A second option enables charging through an accessory power converter 532, which regulates power flow from lower voltage sources received through a second power interface 550 to charge the battery array 510, similar to the charging configuration through the second power interface 450 described in reference to FIG. 5. A third option enables charging through a third power interface 570 and one or more machine load power converters 542 (individually identified as a first machine load power converter 542A, a second machine load power converter 542B, and a third machine load power converter 542C), which are configured to selectively convert voltage power from the third power interface 570 to charge the battery array 510. This multi-charging capability with segmented architecture provides enhanced flexibility for charging in areas with or without high-voltage charging infrastructure.

The battery array 510 employs a segmented architecture with three battery cells 512 (individually identified as a first battery cell 512A, a second battery cell 512B, and a third battery cell 512C). The battery cells 512 may be configured in series, parallel, or a combination of both. The battery cells 512 collectively provide the normal voltage range of the battery array 510, e.g., 1000V-1500V, with 1250V nominal. In some embodiments, a battery cell 512 connects to its dedicated battery bus 516 (516A, 516B, 516C respectively), enabling independent power distribution through dedicated machine load power converters. The battery array 510 includes three battery cells 512 for illustration purposes only, and may include more or fewer cells based on operational requirements. In some embodiments, the battery array 510 may include multiple battery modules, with each module containing multiple battery cells connected in series and/or parallel configurations to achieve desired voltage and current capacities. Unlike a consolidated bus design, this segmented approach enables independent charging through the second power interface 550 and power distribution for each battery cell, while maintaining capability for series charging through the first power interface 520.

The system 500 includes the first power interface 520 configured to receive electrical energy from a first external power source 522 for charging the battery array 510. The first power interface 520 and the first external power source 522 may be similar to the first power interface 420 and the first external power source 422 described in reference to FIG. 4.

During charging via the first power interface 520, the external power source 522 supplies electrical energy at (approximately) the nominal voltage of the battery array 510, or a portion thereof (e.g., the battery cells 512), e.g., (approximately) 1500V. Although FIG. 5 only shows a direct charging connection to battery cell 512A (as illustrated by a dashed line connecting the first power interface 520 and the first battery cell 512A), the charging path may extend to cells 512B and 512C through connections not explicitly shown in the simplified schematic. These connections may be implemented through internal power distribution pathways that maintain appropriate voltage levels for each cell 512 while preserving electrical isolation through the segmented buses 516A, 516B, and 516C. This enables coordinated charging of all battery cells 512 from the first external power source 522 while allowing independent monitoring and control through each cell 512's dedicated bus 516.

The system 500 includes the second power interface 550 configured to receive electrical energy from a second external power source 552 for charging the battery array 510. The second power interface 550 and the second external power source 552 may be similar to the second power interface 450 and the second external power source 452 described in reference to FIG. 4.

The accessory power converter 532 may be bidirectional, which can selectively operate in two modes including a discharge mode and a charge mode. In the discharge mode, the accessory power converter 532 converts power from the battery array 510 to an accessory load 530 (e.g., stepping down from 1500V from the battery array 510 to 715V) for powering the accessory load 530. Exemplary accessory loads include systems such as hydraulics, lighting, and climate control, which operate at lower power levels than the main drive system.

In a charge mode, the accessory power converter 532 regulates power flow by converting lower input voltage (e.g., 400V-1200V) received, through the second power interface 550, from the second external power source 552 to the battery array 510's normal voltage range (e.g., 1000V-1500V, with 1250V nominal). Similar to charging through the first power interface 520, although FIG. 5 only shows a direct charging connection to battery cell 512A (as illustrated by a dashed line connecting the accessory power converter 532 and the first battery cell 512A), the charging path may extend to cells 512B and 512C through connections not explicitly shown in the simplified schematic. These connections may be implemented through internal power distribution pathways that maintain appropriate voltage levels for each cell 512 while preserving electrical isolation through the segmented buses 516A, 516B, and 516C. This enables coordinated charging of all battery cells 512 from the external power source 552 while allowing independent monitoring and control through each cell 512's dedicated bus 516. A discharge operation via the accessory power converter 532 may be similar to the charge operation, with the power flowing in the opposite direction than the charge operation.

For high-power applications, the system 500 may employ one or more machine load power converters 542 (individually identified as a first machine load power converter 542A, a second machine load power converter 542B, and a third machine load power converter 542C) connected in parallel. These converters 542 may collectively convert power from the battery array 510 to power a machine load 540, such as electric drive motors.

The machine load power converters 542 may be bidirectional, which can selectively operate in two modes include a discharge mode and a charge mode. In the discharge mode, the respective converters 542 transforms power from its associated battery cell 512 at approximately 1500V to 2600V to power the machine load 540. During discharge for driving the machine load 540, the converters 542 may work in parallel to provide the desired 2600V output while drawing power from individual cells 512 through their dedicated buses 516.

In the charge mode, the respective converters 542 regulate power flow by converting the input voltage (e.g., approximately 2600V), received through power interface 570 from a third external power source 572, to (substantially) match its respective battery cell 512's normal voltage range (e.g., 1000V-1500V, with 1250V nominal). When charging through the third power interface 570, the converters 542 can regulate charging current independently for their respective cells 512, adapting to different cell states of charge or capacity needs. Examples of the third external power source 572 include industrial electric drive infrastructure, such as mining truck trolley lines, railway catenary systems, industrial DC bus systems, industrial distribution networks that typically supply higher voltages (e.g., above 1500V), etc. Examples of the third power interface 570 include compatible connectors to receive electrical energy from the third external power source 572.

The segmented bus architecture enables independent operation of each converter-cell pair. Through the battery buses 516, the converter 542 can independently control power flow to or from its corresponding cell 512, allowing selective charging or discharging based on individual cell conditions. This configuration differs from a consolidated bus design by enabling cell-level power management while maintaining electrical isolation between cells 512.

The system 500 may include inverters connected to the accessory and machine load power converters, respectively, to enable AC power conversion for both operation and charging. A bidirectional inverter may be connected between the accessory power converter 532 and accessory load 530 to enable conversion between DC and AC power, allowing both AC power output to accessory loads and AC power input for battery charging through power interface 550.

Similarly, bidirectional inverters may be connected between the machine load power converters 542 and machine load 540 to enable AC-DC power conversion in both directions. During machine operation, these inverters convert DC power from the battery array 510 to AC power for driving electric motors or other AC loads. During charging through interface 570, the inverters convert AC power from the third external power source 572 to DC power, which the machine load power converters 542 then regulate to charge their respective battery cells 512.

The system 500 includes a controller assembly (not shown), e.g., the controller assembly 360 as illustrated in FIG. 3 and the controller assembly 600 as illustrated in FIG. 6. The controller assembly may monitor various aspects of the battery array 510, including voltage, current, temperature, and state of charge during both charging and discharging operations. The controller assembly may detect connections between power interfaces (520, 550, or 570) and external power sources (522, 552, or 572), respectively, and controls charging operations through the detected connection.

The controller assembly may distribute charging current based on state of charge levels of individual battery cells 512A, 512B, and 512C through their respective segmented buses 516A, 516B, and 516C. When charging through the second power interface 550, the controller assembly may regulate power flow through the accessory power converter 532 at a reduced power level compared to charging through the first power interface 520. This power regulation may help ensure safe and efficient charging despite the lower supply voltage from the second external power source 552. When charging through the third power interface 570, the controller assembly may regulate power flow through the machine load power converters 542. Each converter 542 may operate independently to charge its associated battery cell 512 through the respective segmented bus. The controller assembly may manage this charging at appropriate power levels based on the input from the third external power source 572, converting from the input voltage (e.g., approximately 2600V) from a third external power source 572 to the battery cells 512′ normal voltage range (e.g., 1000V-1500V, with 1250V nominal). This power regulation through dedicated converters helps ensure safe and efficient charging of individual cells while maintaining proper isolation through the segmented architecture.

The controller assembly may enable coordinated control of multiple system components through the segmented architecture. It may manage the bidirectional operation of the accessory power converter 532 (and inverters), switching between charge and discharge modes based on system needs. The controller assembly may also monitor and control the machine load power converters 542 during high-power operations, ensuring proper power delivery to the machine load 540 through both charging and discharging operations.

FIG. 6 is a schematic illustration of a controller assembly of a battery system in accordance with embodiments of the present disclosure. The controller assembly 600 illustrates an example implementation of the controller assembly 360 in FIG. 3. The controller assembly 600 is a distributed control architecture implementing control functions through specialized modules. The controller assembly 600 includes four control modules that coordinate to manage different aspects of the power system operation, including a battery management module 610, a power interface control module 620, an accessory load control module 630, and a machine load control module 640.

The battery management module 610 monitors and manages battery conditions including voltage, current, temperature, state of charge calculations, etc. It implements battery management algorithms for cell balancing and battery health monitoring, storing critical parameters in local memory. This module provides battery status information to other control modules through industrial communication interfaces.

The power interface control module 620 manages charging operations through multiple power interfaces. It detects connections with external power sources, controls power conversion during charging, and coordinates with external charging systems. The module executes charging control algorithms based on battery conditions and system requirements.

The accessory load control module 630 manages bidirectional power conversion between the battery system and accessory loads. It controls voltage conversion, monitors power flow, and ensures efficient operation of the accessory systems. The module coordinates with other modules to optimize power distribution while maintaining appropriate voltage levels.

The machine load control module 640 controls high-power conversion for machine loads. It manages power delivery to traction systems, implementing control algorithms for efficient power conversion while monitoring converter conditions. The module coordinates with other modules to optimize overall system performance during both charging and operational modes.

The respective modules of the controller assembly 600 may incorporate industrial-grade hardware components designed for reliable operation in work machine environments. The processing hardware includes microcontrollers or microprocessors for executing control algorithms, digital signal processors (DSPs) for high-speed calculations, and field-programmable gate arrays (FPGAs) for time-critical control functions.

The modules 610-640 feature analog-to-digital converters for sensor inputs, digital I/O interfaces for component control, and signal conditioning circuits. Communication hardware includes CAN controllers and transceivers, Ethernet interfaces, or other industrial protocol support. Each module contains local memory including flash storage for program code and RAM for runtime data.

Protection features include isolation components to separate control circuits from high-voltage power systems, surge protection devices, and diagnostic circuits for monitoring module health. The hardware is packaged in ruggedized enclosures with robust electrical connectors, designed to withstand vibration, temperature extremes, and other harsh operating conditions typical in industrial applications.

Redundant communication paths between modules use multiple protocols or channels to ensure reliable data exchange and system coordination, with fail-safe mechanisms to maintain critical functions if communication is disrupted.

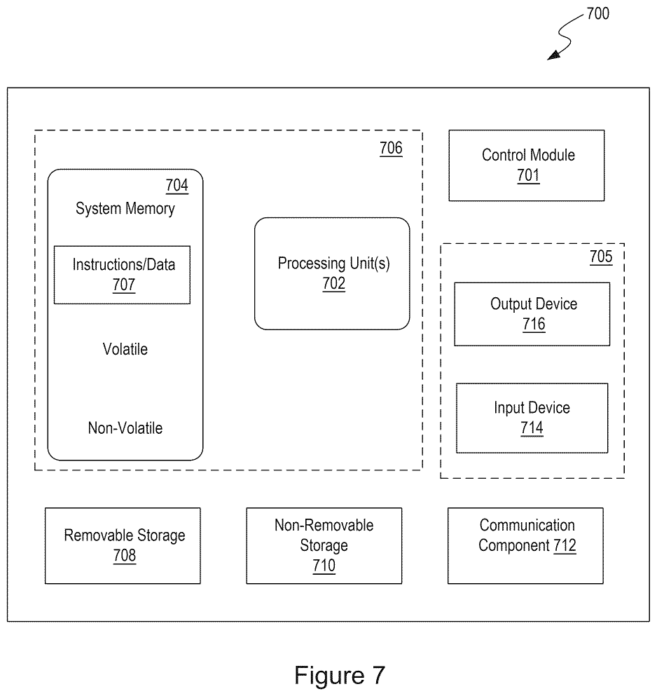

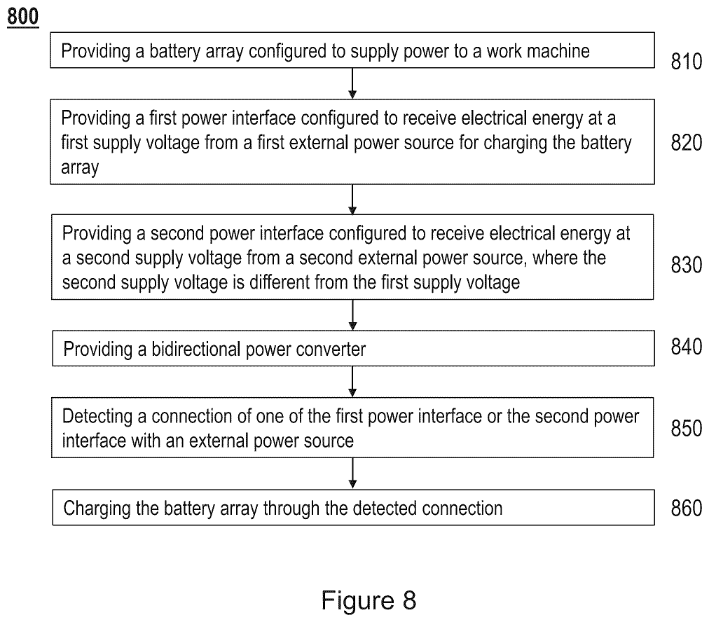

FIG. 7 is a schematic diagram illustrating components in a computing device 700, in accordance with embodiments of the present technology. The computing device 700 can be used to implement methods (e.g., FIG. 8) discussed herein. The computing device 700 can be used to perform the processes/operations discussed in FIGS. 1-6. Note the computing device 700 is only an example of a suitable computing device and is not intended to suggest any limitation as to the scope of use or functionality. Other well-known computing systems, environments, and/or configurations that may be suitable for use include, but are not limited to, personal computers (PCs), server computers, hand-held or laptop devices, multiprocessor systems, microprocessor-based systems, programmable consumer electronics such as smart phones, network PCs, minicomputers, mainframe computers, distributed computing environments that include any of the above systems or devices, and the like.

In its most basic configuration, the computing device 700 includes at least one processing unit 702 and a memory 704. Depending on the exact configuration and the type of computing device, the memory 704 may be volatile (such as a random-access memory or RAM), non-volatile (such as a read-only memory or ROM, a flash memory, etc.), or some combination of the two. This basic configuration is illustrated in FIG. 7 by dashed line 706. Further, the computing device 700 may also include storage devices (a removable storage 708 and/or a non-removable storage 710) including magnetic or optical disks or tape. Similarly, the computing device 700 can have an input device 714 such as keyboard, mouse, pen, voice input, etc. and/or an output device 716 such as a display, speakers, printer, etc. Also included in the computing device 700 can be one or more communication components 712, such as components for connecting via a local area network (LAN), a wide area network (WAN), cellular telecommunication (e.g. 3G, 4G, 5G, etc.), point to point, any other suitable interface, etc.

The computing device 700 can include a control module 701 configured to implement methods for operating the battery system 118 based on one or more sets of parameters corresponding to components of the battery system 118 in various situations and scenarios. For example, the computing device 700 can be configured to implement a control module 701 (e.g., corresponding to the controller assembly 360, the controller assembly 600) for regulating energy change cycles discussed herein. In some embodiments, the control module 701 can be in form of tangibly stored instructions, software, firmware, as well as a tangible device. In some embodiments, the output device 716 and the input device 714 can be implemented as the integrated user interface 705. The integrated user interface 705 is configured to visually present information associated with inputs and outputs of the machines.

The computing device 700 includes at least some form of computer readable media. The computer readable media can be any available media that can be accessed by the processing unit 702. By way of example, the computer readable media can include computer storage media and communication media. The computer storage media can include volatile and nonvolatile, removable and non-removable media (e.g., removable storage 708 and non-removable storage 710) implemented in any method or technology for storage of information such as computer readable instructions, data structures, program modules or other data. The computer storage media can include, a random access memory (RAM), a read-only memory (ROM), an electrically erasable programmable read-only memory (EEPROM), a flash memory or other suitable memory, a compact disc read-only memory (CD-ROM), digital versatile disks (DVD) or other optical storage, magnetic cassettes, magnetic tape, magnetic disk storage or other magnetic storage devices, or any other tangible medium which can be used to store the desired information.

The computing device 700 includes communication media or component 712, including non-transitory computer readable instructions 707, data structures, program modules, or other data. The computer readable instructions 707 can be transported in a modulated data signal such as a carrier wave or other transport mechanism and includes any information delivery media. The term “modulated data signal” means a signal that has one or more of its characteristics set or changed in such a manner as to encode information in the signal. By way of example, the communication media can include wired media such as a wired network or direct-wired connection, and wireless media such as acoustic, radio frequency (RF), infrared and other wireless media. Combinations of any of the above should also be included within the scope of the computer readable media.

The computing device 700 may be a single computer operating in a networked environment using logical connections to one or more remote computers. The remote computer may be a personal computer, a server, a router, a network PC, a peer device or other common network node, and typically includes many or all of the elements described above as well as others not so mentioned. The logical connections can include any method supported by available communications media. Such networking environments are commonplace in offices, enterprise-wide computer networks, intranets and the Internet.

FIG. 8 is a flowchart illustrating a process of charging a battery system, in accordance with embodiments of the present disclosure. The process 800 may be implemented by the controller assembly 360 or 600 for operation on the battery system 118, 300, 400, of 500 described above with reference to FIGS. 3-5.

At block 810, the process 800 includes providing a battery array configured to supply power to a work machine (e.g., work machine 100). In some embodiments, the battery system may include multiple battery cells (or battery modules). See, e.g., descriptions regarding the battery array 310, 410, and 510.

At block 820, the process 800 includes providing a first power interface configured to receive electrical energy at a first supply voltage from a first external power source for charging the battery array. See, e.g., descriptions regarding the first power interface 420 and 520 and the first external power source 422 and 522.

At block 830, the process 800 includes providing a second power interface configured to receive electrical energy at a second supply voltage from a second external power source, where the second supply voltage is different from the first supply voltage. This second supply voltage may be between 400 volts and 1,200 volts, or above 1,500 volts. The second power interface may be 450, 550, or 570. The second external power source may be 452, 552, or 572. Examples of the second external power sources include standard electric vehicle DC fast charging stations that typically supply 400V to 900V, or AC charging stations providing 240V to 480V three-phase power, etc. Additional examples of the second external power sources include industrial electric drive infrastructure, such as mining truck trolley lines, railway catenary systems, industrial DC bus systems, industrial distribution networks that typically supply higher voltages (e.g., above 1500V), etc.

At block 840, the process 800 includes providing a power converter configured to selectively convert power from the battery array to power an accessory (e.g., accessory load 430, 530) or a machine load (e.g., machine load 440, 540) during a discharge mode; or convert electrical energy supplied at the second supply voltage to charge the battery array during a charge mode. See, e.g., descriptions regarding the accessory power converter 432 and 532, and machine load power converter 442 and 542.

At block 850, the process 800 includes detecting a connection of one of the first power interface or the second power interface with an external power source. This detection is performed by a controller assembly of the battery system.

At block 860, the process 800 includes charging the battery array through the detected connection. The specific charging process may vary depending on which interface is connected. If the first power interface is connected, the battery array is charged by receiving electrical energy directly from the first external power source through the first power interface.

If the second power interface is connected, the process includes receiving electrical energy supplied at the second supply voltage from the second external power source, and charging the battery array by regulating, through the power converter, power flow of the received electrical energy.

Throughout the charging process, the controller assembly may distribute charging current based on state of charge (SOC) levels of the plurality of battery cells of the battery system. Additionally, when charging through the second power interface, the controller assembly may regulate power flow at a reduced power level compared to charging from the first power interface.

This process 800 enables flexible charging of the work machine's battery array from multiple power sources, adapting to available infrastructure and optimizing charging based on the connected power source and battery conditions.

In some embodiments, the process 800 may include operations in a discharge cycle. During a discharge cycle, the battery array may supply power to the work machine's electric motors, hydraulic systems, and other components. The controller assembly may monitor the battery state of charge and regulate power distribution to optimize efficiency. Power converters may transform the battery voltage to appropriate levels for different systems. The controller may implement power management strategies such as load shedding or regenerative braking to extend operating time. Sensor data on temperature, current draw, and other parameters may be continuously analyzed to ensure safe operation within design limits. The discharge cycle may continue until the battery state of charge reaches a predetermined lower threshold, at which point the controller may initiate charging or signal the need for charging to the operator.

### INDUSTRIAL APPLICABILITY

The systems and methods disclosed herein address several technical challenges in the field of battery-powered work machines, specifically in the context of charging infrastructure and operational flexibility. These solutions provide benefits for the industrial application of electric and hybrid work machines in various environments.

One technical problem addressed is the limited availability of high-voltage charging infrastructure, especially in remote or temporary work sites. Traditional battery-powered work machines often require specialized high-voltage charging stations, which can be impractical or cost-prohibitive to install in all operational locations. The disclosed multi-interface charging system solves this problem by enabling work machines to utilize a wide range of existing power sources, from high-voltage industrial power to standard electric vehicle charging stations.

Benefits of this technology may include increased operational flexibility, as work machines can be deployed and charged in a wider range of environments, including remote locations with limited infrastructure. The ability to charge from various power sources, including standard EV chargers and industrial power systems, may reduce the need for specialized charging installations, improving utilization of existing infrastructure. Intelligent power management and segmented charging capabilities may allow for optimized energy use and charging strategies, enhancing energy efficiency.

Another technical challenge addressed is the efficient integration of charging capabilities with existing machine components. The bidirectional power converters described in the disclosure serve dual purposes-managing power for machine operations and regulating charging from various sources. This dual-use of power conversion components and reduced need for specialized charging infrastructure can potentially lower overall system and operational costs. Redundant communication paths and fail-safe mechanisms in the control system may enhance overall system dependability in harsh industrial environments.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A system, comprising:
a battery array configured to supply power to a work machine;
a first power interface configured to receive electrical energy supplied at a first supply voltage from a first external power source for charging the battery array;
a second power interface configured to receive electrical energy supplied at a second supply voltage from a second external power source, the second supply voltage being lower than the first supply voltage;
an accessory power converter configured to selectively:
convert power from the battery array to power an accessory during a discharge mode; or
convert electrical energy supplied at the second supply voltage to charge the battery array during a charge mode; and
a controller assembly configured to:
detect a connection of one of the first power interface or the second power interface with an external power source; and
control charging of the battery array through the detected connection.

2. The system of claim 1, wherein the second power interface is further configured to interface with the accessory to output power from the battery array to the accessory.

3. The system of claim 1, wherein the second external power source is a standard mobile charger.

4. The system of claim 3, wherein the second external power source has a supply voltage between 400 volts and 1,200 volts.

5. The system of claim 1, wherein the controller assembly is further configured to control the accessory power converter to regulate power flow of the received electrical energy to charge the battery array at a reduced power level compared to charging from the first power interface.

6. The system of claim 1, wherein:
the battery array comprises a plurality of battery cells; and
the controller assembly is configured to distribute charging current based on state of charge (SOC) levels of the plurality of battery cells.

7. The system of claim 1, further comprising at least one of a machine load power converter or an inverter.

8. A work machine, comprising:
an electric motor; and
a system of claim 1.

9. A method, comprising:
providing a battery array configured to supply power to a work machine;
providing a first power interface configured to receive electrical energy at a first supply voltage from a first external power source for charging the battery array;
providing a second power interface configured to receive electrical energy at a second supply voltage from a second external power source, the second supply voltage being lower than the first supply voltage;
providing an accessory power converter configured to selectively:
convert power from the battery array to power an accessory during a discharge mode; or
convert electrical energy supplied at the second supply voltage to charge the battery array during a charge mode;
detecting a connection of one of the first power interface or the second power interface with an external power source; and
charging the battery array through the detected connection.

10. The method of claim 9, wherein:
detecting a connection of one of the first power interface or the second power interface with an external power source comprises detecting that the second power interface is connected to the second external power source; and
charging the battery array via the detected connection comprises:
receiving, through the second power interface, electrical energy supplied at the second supply voltage from the second external power source; and
charging the battery array by regulating, through the accessory power converter, power flow of the received electrical energy.

11. The method of claim 9, wherein:
detecting a connection of one of the first power interface or the second power interface with an external power source comprises detecting that the first power interface is connected to the first external power source; and
charging the battery array via the detected connection comprises charging the battery array by receiving electrical energy from the first external power source through the first power interface.

12. The method of claim 9, wherein:
the battery array comprises a plurality of battery cells; and
the method further comprises distributing charging current of received electric energy among the plurality of battery cells.

13. A system, comprising:
a battery array comprising a plurality of battery cells;
a first power interface configured to receive electrical energy from a first external power source at a first supply voltage for charging the battery array;
a second power interface configured to receive electrical energy from a second external power source at a second supply voltage that is different from the first supply voltage; and
at least one machine load power converter, each of the at least one machine load power converter being configured to selectively:
convert power from at least one battery cell of the plurality of battery cells to power a machine load during a drive mode; or
convert electrical energy supplied at the second supply voltage to charge the at least one battery cell during a charging mode; and
a controller assembly configured to:
detect a connection of one of the first power interface or the second power interface with an external power source; and
charging the battery array through the detected connection.

14. The system of claim 13, wherein the controller assembly is further configured to, based on detecting a connection of the second power interface with an external power source,
control at least one machine load power converter to operate in the charge mode; and
control charging of one or more battery cells of the plurality of battery cells by regulating, through the at least one machine load power converter, power flow of electrical energy received through the second power interface.

15. The system of claim 13, further comprising at least one machine load inverter configured to:
convert directed current (DC) power from the battery array to alternating current (AC) power for driving an electric motor during the drive mode; and
convert AC power received from the second power interface to DC power for charging the battery array during the charging mode.

16. The system of claim 13, wherein the controller assembly is further configured to, based on detecting a connection of the first power interface with the first external power source, control charging of the battery array by electrical energy received from the first external power source through the first power interface.

17. The system of claim 13, wherein the controller assembly is further configured to:
monitor a state of charge of the battery array during charging; and
terminate charging of the battery array when the state of charge reaches a threshold level.

18. The system of claim 13, wherein the second power interface is configured to receive AC power from the second external power source.

19. The system of claim 13, further comprising an accessory power converter configured to interface with an accessory to output power from the battery array to the accessory.

20. The system of claim 19, further comprising a third power interface configured to receive electrical energy from a third external power source with a supply voltage lower than the first supply voltage, wherein:
the accessory power converter is further configured to regulate power flow of electrical energy received through the third power interface to charge the battery array; and
the controller assembly is further configured to:
detect a connection of the third power interface with the third external power source;
control charging of one or more battery cells of the plurality of battery cells by regulating, through the accessory power converter, power flow of electrical energy received through the third power interface.
